(19) United States
(12) Patent Application Publication
(10) Pub. No.: US 2003/0188448 A1
(43) Pub. Date: Oct. 9, 2003

(54) Breathable rack for storing helmets and the like

(76) Inventor: Michael J. Reed, San Jose, CA (US)

Correspondence Address: Michael J. Hughes, Esq., IPLO, Intellectual Property Law Offices, 1901 S. Bascom Avenue, Suite 660, Campbell, CA, 95008, US

(21) Appl. No.: 10/408,979

(22) Filed: Apr. 7, 2003

Related U.S. Application Data
(60) Provisional application No. 60/371,051, filed on Apr. 8, 2002.

(51) Int. Cl. F26B 19/00; F26B 25/00

(52) U.S. Cl. 34/104; 34/103; 34/90

(57) ABSTRACT

An breathable rack (10) for storing helmets is provided for use in transportation and storage. The rack (10) includes a frame (18) pivotally mounted on a mounting surface (12) to extend between an open position and an closed position. The rack (10) is secured in the closed position by a snap catch (52). A flexible fabric cover member (16) is secured to the frame (18) to support a helmet (12) therein. A drying subsystem (22) including a fan (60) and heating elements (80) facilitates ventilation during use. The rack (10) is especially adapted for use in trailers or storage sheds.

### TECHNICAL FIELD

The present invention relates generally to storage components and more particularly to suspended racks for supporting helmets and similar items.

### BACKGROUND ART

Many sports and activities utilize helmets to protect the heads of the participants. This applies to sports such as snowboarding, vehicle racing, football and skating events as well as work activities where head-protection is desired. Depending on the severity of the risk and the amount of time a person wears the helmet, the helmet may have varying degrees of interior padding.

One of the problems with helmets, particularly those with substantial padding or shaping elements, and especially those designed for maximum cranial cradling, is that they tend to contain perspiration and capture other components such as hair treatments, from the user. This means that it is necessary to provide a way for the helmet to “air out” between uses or odors and more serious problems, such as mildew, can occur.

In some sports, such as motor racing, all of the equipment for a person, or team, will be maintained in a moving vehicle such as a trailer between uses. This means that it is not only necessary to provide support for ventilation, but also secure storage under turbulent conditions.

Various methods have been utilized to help dry out helmets and headgear in the interim between uses. Some of the simplest are pegs upon which the headgear can be hung and cabinets/lockers in which they may be set. Some sort of air circulation mechanism is desirable, but this is often neglected. Problems are often encountered in securing the helmet in position, efficient storage arrangements, cost of manufacture and installation and efficiency of drying. No previously observed methods have proven to be optimal for a wide variety of storage situations.

In light of the great need for finding ways to store and ventilate helmets and other items, there exists an opportunity to refine and improve the structures and methods. In particular, helmet storage devices which facilitate ventilation while retaining the helmet securely and efficiently are desired.

### SUMMARY OF THE INVENTION

Accordingly, it is an object of the present invention to provide a storage and ventilation system for helmets, other types of headgear and other accoutrements for activities.

Another object of the invention is to provide a storage rack for helmets which is adaptable for efficient mounting in a variety of orientations.

Still another object of the invention is to provide a mounting system which secures the headgear in place and provides protection under turbulent conditions, while being easy to open when access is desired.

Yet another object of the invention is to provide a storage system which is usable, without modification, with varying shapes and sizes of helmets or other contents.

Briefly, a preferred embodiment of the present invention is a storage rack for helmets which is constructed so as to be breathable so that the contents may ventilate during storage. The storage rack is adapted to restrain and enclose helmets of varying sizes and shapes and to facilitate ventilation and drying of the contents during storage. The invention is particularly adapted for use in vehicles, such as trailers used in racing, and other mobile units where helmets are often stored between usages. The storage rack is provided with a breathable cover which permits air and moisture to flow therethrough. Optional features, such as a drying subsystem to increase air flow and reduce drying time are compatible with the rack.

A simple preferred embodiment is intended to store and breathably protect a helmet against a mounting surface. The rack system includes a breathable cover stretched over a frame which is pivotally mounted on the mounting surface by mounting hardware. Deluxe embodiments include an optional drying system which may be directly mounted on the mounting surface or may incorporate a separate base structure. The drying systems utilize additional components which cause air flow in the space defined by the rack in order to enhance ventilation and drying of the helmet.

An advantage of the present invention is that it is simple to install and use and provides ventilation during storage.

Another advantage of the present invention is that it is well adapted for use in mobile facilities, such as racing trailers.

A further advantage of the invention is provides secure storage of helmets under turbulent conditions, such as when being towed between sites.

Still another advantage of the invention is that it utilizes vertical surfaces and the undersides of planar surfaces such as workbenches, as viable storage locations.

Yet another advantage of the invention is that the storage rack lies relatively flat and takes up little space when empty.

Other advantages of the invention are that the fabric cover is breathable to facilitate ventilation, soft to prevent scratching and damage to contents, stretchable to adapt to contents of varying sizes and shapes and washable for easy cleaning.

A still further advantage of the invention is that it is durable and has a mechanism for replacement of less-durable components, such as the cover, when necessary.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

FIG. 1 is a perspective view of a rack of the present invention, shown in a closed position and containing a typical helmet;

FIG. 2 is a perspective view of a rack according to an embodiment of the invention, shown in an open position;

FIG. 3 is a plan view of the frame, mounting hardware and drying apparatus portions of one embodiment of the invention, shown disposed on a mounting surface; and

FIG. 4 is an exploded perspective view of a ventilation base component of a deluxe embodiment the invention, adapted to maximize drying of the contents during storage.

### BEST MODE FOR CARRYING OUT THE INVENTION

The present invention is a system adapted for storing bulky, irregularly shaped objects, particularly helmets, in a manner which allows ventilation and drying during storage. A preferred embodiment of the invention, a breathable rack for storing helmets and the like, is illustrated in the several figures of the drawing and is designated by the general reference character 10.

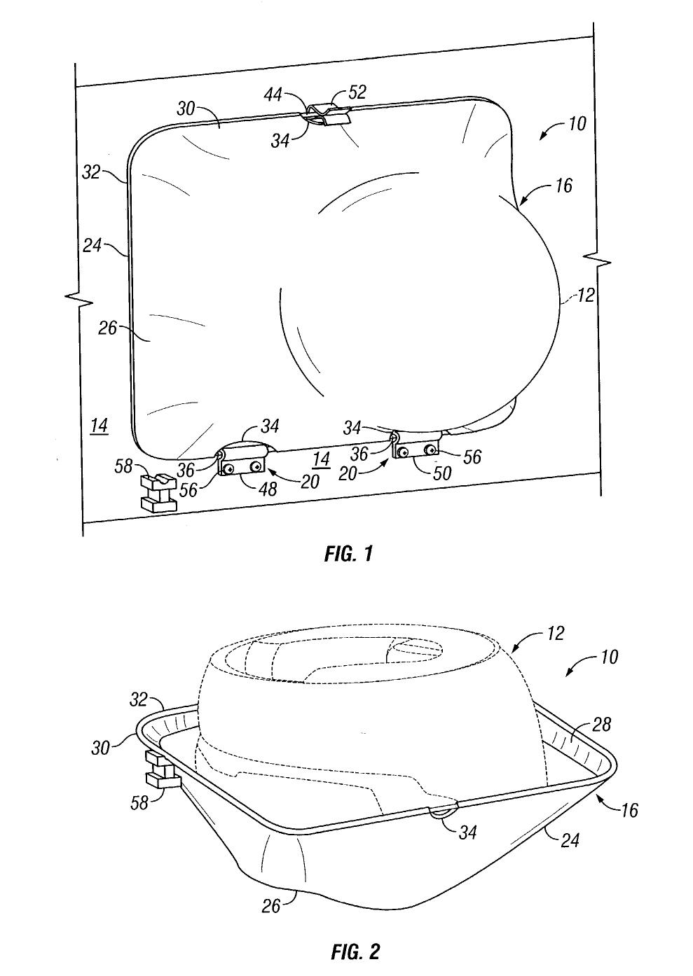

Referring now to FIG. 1, the simple preferred embodiment of the rack system 10 is shown in a perspective view, containing a helmet 12 and installed upon a mounting surface 14. In FIG. 1, the rack 10 is shown in a “closed” position, with the helmet 12 enclosed therein. In the illustration, the mounting surface 14 is shown as a vertical wall, such as the side wall on the interior of a trailer. However, a ceiling, underside of a bench, inclined surface or other generally planar surface will also work. The illustration shows a solid mounting surface 14, as this will typically be the case in most applications, but enhanced functionality may be achieved if the surface is a screen or other breathable surface.

In a similar fashion, the rack 10 is illustrated in an “open” configuration in FIG. 2. In this view the inside surface of the rack 10, as well as the exposed helmet 12 can be seen. The rack system 10 is adapted to enclose the helmet 12, or other contents; between a portion of the rack and the mounting surface 14. When open, the rack pivots out from the mounting surface 14 and presents the helmet 12 for unloading (FIG. 2) or loading.

The rack system 10 includes various functional components, including a cover 16, a frame 18, a variety of mounting hardware 20 and, in deluxe embodiments such as the ones illustrated in FIGS. 3 and 4, a drying subsystem 22.

The cover aspects 16 are best illustrated in FIGS. 1 and 2 and the cover 16, while essentially unitary in structure, may be considered to be a stretchable fabric swatch 24 having a central expanse 26 and a periphery 28. The periphery 28 is formed into a circumferential tube 30 which encompasses the frame 18. The tube 30 is formed by a seam 32 in the preferred embodiment, but may be secured in another fashion, such as by heat welding.

The cover 16 is formed of a breathable material, such as a Lycra® fabric or a similar materials which permits flow of air and moisture. It is desirable that the material also be stretchable in order to provide reasonably secure containment of objects of varying configurations, as helmets come in a variety of shapes and sizes. Stretchable netting or other flexible sheet or web materials may also be utilized.

At three locations about the periphery 28, an aperture 34 is formed in the cover 16. These apertures 34 provide areas where the frame is not directly enclosed by the cover. The apertures 34 facilitate the pivoting and closure of the rack 10, and help prevent fouling of the interaction between the frame 18 and the mounting hardware 20.

The structures of the frame 18, the mounting hardware 20 and the surface-mounted drying subsystem 22 are best illustrated in FIG. 3. The frame 18 and mounting hardware 20 facilitate the pivotal operation of the rack 10 and support the cover 16 in a fashion to enclose the helmet 12. The frame 18 supports the cover 16 in such a manner that the cover 16 can stretch to elastically hold the helmet in position, and interacts with the mounting 20 hardware to open and close for insertion and retention.

The frame 18 is essentially a single extent of metallic rod 36 which is formed in an optimal manner to fit around the desired contents. A formed rod of another material, such as cast plastic, could also be used. In the preferred embodiment 10, the metallic rod 36 includes a gap 38 which is preferably situated on a hinge portion 40 (rear) of the frame. The gap 38 represents the location of the ends of the rod 36, and provides a means by which the cover 16 may be installed or replaced (as needed). Obviously, this may only occur when the frame is removed from the mounting hardware 20. The frame also includes a pair of opposing side portions 42 and a clasp portion 44 (front). A beveled corner portion 46 exists at each corner, with the gentle curvature being optimal for stretching the fabric swatch 24. It is recognized that the presented shape is selected to correspond to racing helmets and that other shapes and configurations could be equally effective, depending on the desired contents.

The mounting hardware 20, in the preferred embodiment 10, includes a first hinge plate 48, a second hinge plate 50, and a snap catch 52. An optional latch 54 may be provided in some embodiments to prevent the snap catch 52 from releasing during turbulent transport, or the like. The optional latch is particularly valuable if the rack 10 is mounted to depend form a horizontal surface, such as the underside of a shelf or form a ceiling, or when significant turbulence is expected and the snap catch cannot be relied upon to keep the rack in the closed position. Each of the components of the mounting hardware 20 is secured to the mounting surface 14 by screws 56 in the preferred embodiment 10, but any other securing means, such as adhesives, bolts, nails and the like would suffice for most applications.

An optional stop member 58 may also be provided to arrest the degree of pivoting of the frame 18 about the hinges 48 and 50. This may be desirable to have the open configuration present a convenient cradle for receiving the helmet 12. Ordinarily, once a helmet 12 is placed within the cover 16, the rack 10 will remain in an open position without mechanical assistance (as in the illustration of FIG. 2). However, the additional stop member 58 may be useful when the mounting is on a vertical surface and the rotation of the frame 18 is desired to be limited to a ninety degree arc.

Another optional component is the drying subsystem 22. The basic embodiment of FIGS. 1 and 2 does not utilize any additional components to facilitate drying, relying instead on ambient conditions for air flow and ventilation. However, in some climates and uses, this is not adequate, and additional effort is desirable.

One embodiment, a surface-mounted drying system 22′, is illustrated in FIG. 3. The drying subsystem 22 is a method for enhancing the air circulation inside the object, be it a helmet 12 or something else. The configuration 22′ shown in FIG. 3 is adapted for enhanced drying of a helmet 12 or other similar hollow interior structure. The surface-mounted drying subsystem 22′ shown in FIG. 3 includes an electrical fan 60, a plurality of baffles 62 to direct the air flow, each secured to the mounting surface 14, and a switch mechanism 64 to activate the fan 60. The fan 60 and baffles 62 are adapted to fit within the cavity of the helmet 12. For some types of contents it may also be necessary to include spacers (not shown) to prevent the helmet 12 from unduly sealing against the mounting surface 14 and creating undesirable dead air space. The baffles 62 can also perform this function.

The precise type of fan 60 utilized is a matter of choice and may range from a simple battery operated plastic fan to a sophisticated multi-speed air circulator with a humidity activated switch mechanism. One specifically envisioned form of switch mechanism 64 would be activated by the movement of a loaded storage rack into the closed position.

A further deluxe drying subsystem 22″ is illustrated in an exploded perspective view in FIG. 4. This subsystem 22″ is adapted for use in situations where a greater degree of drying is required, such as for frequently used helmets, or hot and humid climate conditions. In the deluxe drying subsystem 22″ an intermediate ventilation base 66 is imposed between the mounting surface 14 and the frame 18 in order to facilitate ventilation and to contain optional heating and air flow components.

As shown in FIG. 4, the deluxe drying subsystem 22″ includes the ventilation base 66 upon which the mounting hardware 20 is attached. The ventilation base 66 includes a peripheral base frame 68, and inner frame 68 and a mounting plate 72. The mounting plate 72 serves the function of the mounting surface 14 for the remainder of the rack 10. The mounting plate 72 includes an central aperture 74 over which a porous membrane 76 is placed. The various components are held together (and to the actual mounting surface 14) by screws 56 or other fasteners.

The outer frame is provided with a plurality of ventilation slots 78 which facilitate airflow. Air flow is also facilitated through the porous membrane 76, which is situated to oppose the cavity in the helmet 12 or other object to be contained in the rack 10.

Optional components are also provided in the deluxe drying subsystem 22″ and these are mounted within the inner frame 70. One or more heating elements 80 may be provided to heat the interior space and cavity of the helmet 12.

In the embodiment shown in FIG. 4 the heating elements 80 are in the form of light bulbs 82. The light bulb 82 elements are selected for a variety of purposes, including the ability to be powered by low voltage DC electrical power normally available on trailers, and the external visibility factor, which allows the user to determine whether the heating element 80 is activated. It has been found that the small amount of heat generated by automotive lights is sufficient for drying under most conditions. As shown in FIG. 4 two bulbs 82 are provided in order to provide low or “high” heating to the cavity. Other forms of heating elements 80 may also be used. An optional fan 60 may also be provided to facilitate air flow and speed up the drying process.

It is noted that the porous membrane 76 is positioned between the beating elements 80 and the helmet 12. This helps to prevent degradation of the helmet material from direct radiation, while allowing the heat to be carried by convection throughout the cavity.

Electrical wiring is provided from the electrical components in the interior frame 70 to the exterior of the base frame 68 in order to connect to a multi-switch 86 which is accessible to the user. The deluxe embodiment of the drying subsystem 22″ shown includes the multi-switch 86 to control both the heating elements 80 and the fan 60. The multi-switch 86 selected includes a three-position switch 88 for the light bulbs 82 and a fan switch 90. The three-position switch 88 may be set to be off, or to activate one or both bulbs, depending on the amount of heating desired by the user. The fan switch 90 is typically a simple on-off switch, although a variable speed switch could also be used.

The use of the optional drying subsystems 22 illustrated in FIGS. 3 and 4 can aid in ventilating and drying the helmets or other contents and enhance the desirability of the rack system 10. However, it is recognized that not all users will require these and it is also recognized that many alternate structures and components may be substituted.

In addition to the above mentioned examples, various other modifications and alterations of the breathable rack system for storing helmets may be made without departing from the invention. Accordingly, the above disclosure is not to be considered as limiting and the appended claims are to be interpreted as encompassing the entire spirit and scope of the invention.

### INDUSTRIAL APPLICABILITY

As described above, the present invention is utilized in many applications where an object such as a helmet or other headgear needs to be stored in a simple and secure fashion. In particular the storage rack of the present invention is intended for use in storing helmets for sporting activities, such as racing or snowmobiling, where ventilation and drying of the headgear between uses is highly desirable. The invention is especially adapted to be optimal for use in the interior of truck and trailers used in such activities. As such it provides compact and secure storage while also facilitating ventilation.

The operation of the system is as shown in the drawing and described above. The rack 10 is either mounted directly on a mounting surface 14 or on a ventilation base 66 which is secured to eh mounting surface 14. The mounting is accomplished by installing the mounting hardware 20, with the first and second hinges (48 and 50) enclosing the hinge portion 40 of the frame rod 36 in a pivotal fashion so that the rack 10 may pivot from a fully open position (FIG. 2) to a closed position (FIG. 1). The open position shown in FIG. 2 is for a rack 10 mounted on a vertical mounting surface 14 and where the rotation is arrested by the optional stop member 57.

When the rack 10 is in the open position a helmet 12 or similar object may be placed on the interior surface of the cover 16, with the open side of the helmet oriented so as to abut against the mounting surface 14 when the rack 10 is closed. When the frame 18 is pivoted on the hinges to the closed position, the snap catch 52 engages the clasp portion 44 of the frame rod 36 and hold the rack 10 closed. If no external activation switch mechanism 64 is provided, it may be necessary to manually activate the fan 60 before closing the rack 10.

The mounting of the cover 16 on the frame 18 is such that the snap catch 52 is oriented opposite one aperture 34 so the snap catch 52 does not foul on the tube 30 of the fabric, while the other two apertures 34 are situated at the hinge locations. If additional security is needed, the securing latch 54 may be engaged. This is particularly valuable for use in vehicles where significant vibration and turbulence might otherwise result in disengagement of the snap catch 52. It may also be desirable to utilize only a latch 54 instead of a snap catch 52 for some applications.

The breathability of the cover 16 facilitates drying and ventilation of the helmet 12 during storage, and this is enhanced if the drying subsystem 22 is provided and activated. For high-humidity or frequent use applications, the deluxe drying subsystem 22″ provides substantially enhanced drying. This makes the present invention especially desirable for applications where a helmet must be reused at relatively short intervals and transported between uses.

For the above, and other, reasons, it is expected that the storage rack system of the present invention will have widespread industrial applicability. Therefore, it is expected that the commercial utility of the present invention will be extensive and long lasting.

I claim:

1. A rack system for mounting on a generally planar surface and being adapted for storing bulky items which benefit from ventilation during storage, comprising:
an open peripheral frame member formed of rigid rod portions;
hinge means secured to the planar surface and enclosing one said portion of the frame member such that said frame member pivots about the hinge means;
securing means to mate with a portion of the frame member so as to releasably secure the frame member against the planar surface when engaged therewith; and
a breathable flexible cover member secured to the open frame member so as to form an enclosing volume between the cover member and the planar surface.

2. The rack system of claim 1 and further including a drying subsystem having at least one heating element and at least one air circulation element.

3. The rack system of claim 1, wherein said breathable cover is a stretchable fabric material.

4. The rack system of claim 1, wherein said cover member is provided with a tubular periphery for slidably fitting over said frame member.

5. The rack system of claim 1, wherein said securing means is a snap catch.

6. The rack system of claim 1 and further including a latch member for firmly holding the rack system in a closed position with the bulky items stored within.

7. A helmet rack for use in storing helmets against a mounting surface, comprising:
a generally rectangular frame member pivotally secured to the mounting surface by mounting hardware;
a breathable elastic cover member secured to the frame to enclose a helmet between the cover member and the mounting surface; and
a catch member for releasably capturing the frame member against the mounting surface.

8. The helmet rack of claim 7 and further including a drying subsystem having air circulation means and heating means situated within a cavity formed between said cover member and the mounting surface.

9. The helmet rack of claim 8 wherein said drying subsystem further includes a ventilation frame mounted on the mounting surface, said ventilation frame providing an alternate mounting surface for pivotally securing said frame member, said ventilation frame enclosing said air circulation means and said heating means.

10. The helmet rack of claim 9 wherein a porous membrane is provided on said ventilation frame within said cavity to physically separate said heating means from the helmet.

11. The helmet rack of claim 8 wherein said heating means are light bulbs powered by automotive DC current.

12. A breathable storage rack, comprising:
a frame member pivotally secured to a surface to pivot from an open position to a closed position;
a breathable cover attached to said frame member to form, with said frame member and the surface, an enclosed space within which an object may be stored when said frame member is in the closed position; and
releasable catch means for securing said frame member in the closed position.

13. The storage rack of claim 12 and further including a drying subsystem for facilitating drying of the object, the drying subsystem including a fan.

14. The storage rack of claim 12 and further including a drying subsystem for facilitating drying of the object, the drying subsystem including at least one heating element.

15. The storage rack of claim 14 wherein said heating element is an electrical light bulb.

16. The storage rack of claim 16 wherein said drying subsystem includes electrical components adapted to be powered by automotive DC voltage.

17. The storage rack of claim 14 wherein a pair of said heating elements are provided, along with a three position switch facilitating activation of zero, one or both of said heating elements.

18. The storage rack of claim 12 wherein said frame member is formed of metallic rod formed in a generally rectangular outline, with a gap in one side in order to receive a tube formed in the periphery of said cover member in such a way that cover is held about said frame.

19. The storage rack of claim 12 wherein said frame member is pivotally secured to the surface by a pair of hinge members.
